(19) United States
(12) Patent Application Publication
(10) Pub. No.: US 2025/0119929 A1
(43) Pub. Date: Apr. 10, 2025

(54) METHOD AND APPARATUS FOR PROCESSING SIDELINK TRANSMISSION IN UNLICENSED BAND, AND RELATED DEVICE

(71) Applicant: VIVO MOBILE COMMUNICATION CO., LTD., Dongguan (CN)

(72) Inventors: Siqi LIU, Dongguan (CN); Zichao JI, Dongguan (CN)

(73) Assignee: VIVO MOBILE COMMUNICATION CO., LTD., Dongguan (CN)

(21) Appl. No.: 18/986,926

(22) Filed: Dec. 19, 2024

Related U.S. Application Data
(63) Continuation of application No. PCT/CN2023/099896, filed on Jun. 13, 2023.

(30) Foreign Application Priority Data
Jun. 20, 2022 (CN) 202210701660.7

(51) Int. Cl. H04W 72/25; H04W 72/40

(52) U.S. Cl. CPC H04W 72/25; H04W 72/40

(57) ABSTRACT

This application provides a method and an apparatus for processing sidelink transmission in an unlicensed band, and a related device. The method includes: obtaining, by a first terminal, first information; and determining, by the first terminal, whether to perform a first behavior or whether a first behavior needs to be performed. The first information includes at least one of first preset information or second preset information. The first behavior includes at least one of: monitoring a first resource object according to the first information or using the first resource object according to the first information. When a first preset condition is met, the first terminal determines to perform the first behavior or that the first behavior needs to be performed.

### CROSS-REFERENCE TO RELATED APPLICATIONS

This application is a continuation of International Application No. PCT/CN 2023/099896, filed on Jun. 13, 2023, which claims priority to Chinese Patent Application No. 202210701660.7, filed on Jun. 20, 2022. The entire contents of each of the above-referenced applications are expressly incorporated herein by reference.

### TECHNICAL FIELD

This application pertains to the field of communication technologies, and specifically, to a method and an apparatus for processing sidelink transmission in an unlicensed band, and a related device.

### BACKGROUND

With development of communication technologies, in a future communication system, a shared spectrum such as an unlicensed band may be used as a supplement to a licensed band, to help an operator expand services. In a Sidelink (SL) communication system, to obtain more resources to meet service requirements (such as SL-based extended reality, virtual reality, or positioning services) in SL transmission, SL transmission may be required in an unlicensed band. However, a framework of a current SL technology is mainly designed for a licensed band or an Intelligent Transportation System (ITS) band. Due to possible presence of other wireless technologies such as wireless fidelity (Wi-Fi) in the unlicensed band, it is necessary to sense whether a resource is idle and attempt to initiate channel access after determining that the resource is idle.

Currently, a network-side device usually schedules a terminal to monitor a channel. Because the network-side device does not receive an SL channel/signal sent by the terminal, it is impossible to know whether access of the terminal is actually successful. Consequently, a status of the terminal is incorrectly determined by the network-side device, and the terminal is inappropriately scheduled. Therefore, the prior art has a problem that reliability of SL transmission performed in the unlicensed band is poor.

### SUMMARY

Embodiments of this application provide a method and an apparatus for processing sidelink transmission in an unlicensed band, and a related device.

According to a first aspect, a method for processing sidelink transmission in an unlicensed band is provided and includes:
obtaining, by a first terminal, first information, where the first information includes at least one of first preset information and second preset information, and the first preset information and/or the second preset information includes at least one of monitoring information and information of a preset resource; and
determining, by the first terminal, whether to perform a first behavior or whether a first behavior needs to be performed, where the first behavior includes at least one of: monitoring a first resource object according to the first information and using the first resource object according to the first information, where
in a case that a first preset condition is met, the first terminal determines to perform the first behavior or that the first behavior needs to be performed, and the first preset condition includes at least one of the following: the first terminal belongs to M terminals that include at least part of terminals associated with the first preset information, and the first terminal does not belong to N terminals that include at least part of terminals associated with the second preset information, where both M and N are positive integers.

According to a second aspect, a method for processing sidelink transmission in an unlicensed band is provided and includes:
in a case that a fourth terminal knows target information, performing, by the fourth terminal, a fourth behavior, where
the target information includes at least one of the following: a second terminal determines that a first resource object is idle or available; the second terminal successfully accesses or obtains the first resource object; and the second terminal uses the first resource object;
the fourth behavior includes at least one of the following: determining that the first resource object is occupied by the second terminal; determining that the first resource object is occupied by a sidelink system; determining that the first resource object is occupied by at least part of terminals corresponding to a fifth identifier, where the at least part of the terminals corresponding to the fifth identifier include the second terminal; and determining second information in a case that the fourth terminal belongs to the at least part of the terminals corresponding to the fifth identifier; and
the second information includes at least one of the following: a second resource object, where the second resource object at least partially overlaps the first resource object; a requirement for monitoring the second resource object; a need to monitor the second resource object; and use of the second resource object.

According to a third aspect, a method for processing sidelink transmission in an unlicensed band is provided and includes:
sending, by a network-side device, first information to a first terminal, where the first information includes at least one of first preset information and second preset information, and the first preset information and/or the second preset information includes at least one of monitoring information and information of a preset resource.

According to a fourth aspect, an apparatus for processing sidelink transmission in an unlicensed band is provided. The apparatus is applied to a first terminal and includes:
an obtaining module, configured to obtain first information, where the first information includes at least one of first preset information and second preset information, and the first preset information and/or the second preset information includes at least one of monitoring information and information of a preset resource; and
a first determining module, configured to determine whether to perform a first behavior or whether a first behavior needs to be performed, where the first behavior includes at least one of: monitoring a first resource object according to the first information and using the first resource object according to the first information, where
in a case that a first preset condition is met, the first terminal determines to perform the first behavior or that the first behavior needs to be performed, and the first preset condition includes at least one of the following: the first terminal belongs to M terminals that include at least part of terminals associated with the first preset information, and the first terminal does not belong to N terminals that include at least part of terminals associated with the second preset information, where both M and N are positive integers.

According to a fifth aspect, an apparatus for processing sidelink transmission in an unlicensed band is provided. The apparatus is applied to a fourth terminal and includes:
a second execution module, configured to perform a fourth behavior in a case that the fourth terminal knows target information, where
the target information includes at least one of the following: a second terminal determines that a first resource object is idle or available; the second terminal successfully accesses or obtains the first resource object; and the second terminal uses the first resource object;
the fourth behavior includes at least one of the following: determining that the first resource object is occupied by the second terminal; determining that the first resource object is occupied by a sidelink system; determining that the first resource object is occupied by at least part of terminals corresponding to a fifth identifier, where the at least part of the terminals corresponding to the fifth identifier include the second terminal; and determining second information in a case that the fourth terminal belongs to the at least part of the terminals corresponding to the fifth identifier; and
the second information includes at least one of the following: a second resource object; a requirement for monitoring the second resource object, where the second resource object at least partially overlaps the first resource object; a need to monitor the second resource object; and use of the second resource object.

According to a sixth aspect, an apparatus for processing sidelink transmission in an unlicensed band is provided. The apparatus is applied to a network-side device and includes:
a second sending module, configured to send first information to a first terminal, where the first information includes at least one of first preset information and second preset information, and the first preset information and/or the second preset information includes at least one of monitoring information and information of a preset resource.

According to a seventh aspect, a terminal is provided. The terminal includes a processor and a memory. The memory stores a program or instructions capable of running on the processor. When the program or instructions are executed by the processor, the steps of the method according to the first aspect are implemented, or the steps of the method according to the second aspect are implemented.

According to an eighth aspect, a terminal is provided and includes a processor and a communication interface. When the terminal is a first terminal, the communication interface is configured to obtain first information, where the first information includes at least one of first preset information and second preset information, and the first preset information and/or the second preset information includes at least one of monitoring information and information of a preset resource; and the processor is configured to determine whether to perform a first behavior or whether a first behavior needs to be performed, where the first behavior includes at least one of: monitoring a first resource object according to the first information and using the first resource object according to the first information, where
in a case that a first preset condition is met, the first terminal determines to perform the first behavior or that the first behavior needs to be performed, and the first preset condition includes at least one of the following: the first terminal belongs to M terminals that include at least part of terminals associated with the first preset information, and the first terminal does not belong to N terminals that include at least part of terminals associated with the second preset information, where both M and N are positive integers.

In some embodiments, when the terminal is a fourth terminal, the processor is configured to perform a fourth behavior in a case that the fourth terminal knows target information, where
the target information includes at least one of the following: a second terminal determines that a first resource object is idle or available; the second terminal successfully accesses or obtains the first resource object; and the second terminal uses the first resource object;
the fourth behavior includes at least one of the following: determining that the first resource object is occupied by the second terminal; determining that the first resource object is occupied by a sidelink system; determining that the first resource object is occupied by at least part of terminals corresponding to a fifth identifier, where the at least part of the terminals corresponding to the fifth identifier include the second terminal; and determining second information in a case that the fourth terminal belongs to the at least part of the terminals corresponding to the fifth identifier; and
the second information includes at least one of the following: a second resource object, where the second resource object at least partially overlaps the first resource object; a requirement for monitoring the second resource object; a need to monitor the second resource object; and use of the second resource object.

According to a ninth aspect, a network-side device is provided. The network-side device includes a processor and a memory. The memory stores a program or instructions capable of running on the processor. When the program or instructions are executed by the processor, the steps of the method according to the third aspect are implemented.

According to a tenth aspect, a network-side device is provided and includes a processor and a communication interface. The communication interface is configured to send first information to a first terminal, where the first information includes at least one of first preset information and second preset information, and the first preset information and/or the second preset information includes at least one of monitoring information and information of a preset resource.

According to an eleventh aspect, a communication system is provided and includes a terminal and a network-side device. The terminal may be configured to perform the steps of the method for processing sidelink transmission in an unlicensed band according to the first aspect or the second aspect. The network-side device may be configured to perform the steps of the method for processing sidelink transmission in an unlicensed band according to the third aspect.

According to a twelfth aspect, a readable storage medium is provided. The readable storage medium stores a program or instructions. When the program or instructions are executed by a processor, the steps of the method according to the first aspect are implemented, or the steps of the method according to the second aspect are implemented.

According to a thirteenth aspect, a chip is provided. The chip includes a processor and a communication interface. The communication interface is coupled to the processor. The processor is configured to run a program or instructions to implement the steps of the method according to the first aspect, or implement the steps of the method according to the second aspect, or implement the steps of the method according to the third aspect.

According to a fourteenth aspect, a computer program or program product is provided. The computer program or program product is stored in a storage medium. The computer program or program product is executed by at least one processor to implement the steps of the method according to the first aspect, or implement the steps of the method according to the second aspect, or implement the steps of the method according to the third aspect.

In the embodiments of this application, the first terminal obtains the first information, and determines whether to perform the first behavior or whether the first behavior needs to be performed, where the first behavior includes at least one of: monitoring the first resource object according to the first information and using the first resource object according to the first information. In this way, the terminal can autonomously determine whether to monitor the first resource object according to the first information and/or use the first resource object according to the first information, thereby increasing autonomous selection behaviors of the terminal, further avoiding incorrect scheduling by the network-side device, and improving reliability of SL transmission performed by the terminal in the unlicensed band.

### BRIEF DESCRIPTION OF DRAWINGS

FIG. 1 is a schematic structural diagram of a network to which an embodiment of this application can be applied;

FIG. 2 is a flowchart of a method for processing sidelink transmission in an unlicensed band according to an embodiment of this application;

FIG. 3 is an exemplary diagram of a communication scenario to which a method for processing sidelink transmission in an unlicensed band is applied according to an embodiment of this application;

FIG. 4 is an exemplary diagram of another communication scenario to which a method for processing sidelink transmission in an unlicensed band is applied according to an embodiment of this application;

FIG. 5 is a second flowchart of another method for processing sidelink transmission in an unlicensed band according to an embodiment of this application;

FIG. 6 is a flowchart of still another method for processing sidelink transmission in an unlicensed band according to an embodiment of this application;

FIG. 7 is a structural diagram of an apparatus for processing sidelink transmission in an unlicensed band according to an embodiment of this application;

FIG. 8 is a structural diagram of another apparatus for processing sidelink transmission in an unlicensed band according to an embodiment of this application;

FIG. 9 is a structural diagram of still another apparatus for processing sidelink transmission in an unlicensed band according to an embodiment of this application;

FIG. 10 is a structural diagram of a communication device according to an embodiment of this application;

FIG. 11 is a structural diagram of a terminal according to an embodiment of this application; and

FIG. 12 is a structural diagram of a network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a long term evolution (LTE)/LTE-Advanced (LTE-A) system, and can also be used in other wireless communication systems, such as code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the new radio (NR) system is described for an illustrative purpose, and NR terms are used in most of the following descriptions. These technologies may also be applied to other applications than an NR system application, for example, a 6th Generation (6G) communication system.

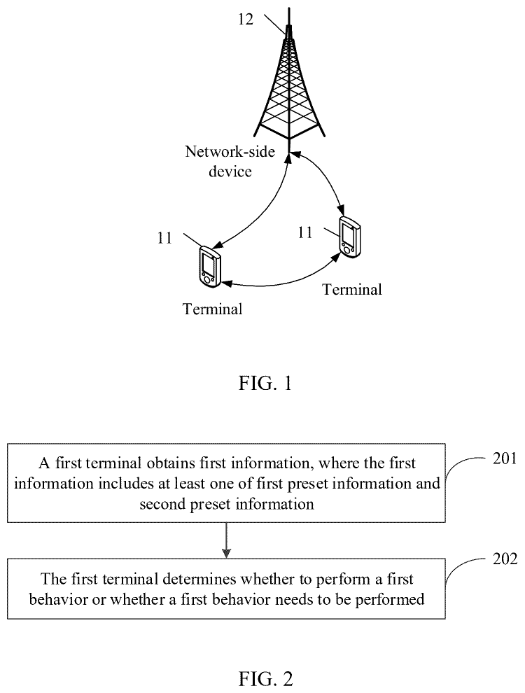

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, vehicle user equipment (VUE), pedestrian user equipment (PUE), a smart home (a home device having a wireless communication function, such as a refrigerator, a television, a washing machine, or furniture), a game console, a personal computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a radio access network (RAN), a radio access network function, or a radio access network element. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a Transmitting Receiving Point (TRP), or another appropriate term in the art. As long as the same technical effect is achieved, the base station is not limited to specific technical terms. It should be noted that in the embodiments of this application, only a base station in an NR system is used as an example for description, but a specific type of the base station is not limited.

For ease of understanding, the following describes some content in the embodiments of this application.

### I. Shared Spectrum and Unlicensed Band

In a future communication system, a shared spectrum such as an unlicensed band may be used to supplement a licensed band, to help an operator expand services. To keep consistency with NR deployment and maximize NR-based unlicensed access as much as possible, the unlicensed band can work in 5 GHZ, 37 GHz, and 60 GHz bands. Because the unlicensed band is shared by a plurality of radio access technologies (RATs), such as Wi-Fi, radar, and long term evolution license assisted access (LTE-LAA), in some countries or regions, use of the unlicensed band needs to comply with regulations, such as listen before talk (LBT), a maximum channel occupancy time (MCOT), and other regulations, to ensure that all devices can use the resource fairly. When a transmission node needs to send information, the transmission node needs to perform LBT first and perform energy detection (ED) on nearby nodes. When detected power is lower than a threshold, a channel is considered as idle and the transmission node can send the information. Otherwise, the channel is considered as busy and the transmission node cannot send the information. The transmission node may be a base station, a terminal, a Wi-Fi access point (AP), or the like. After the transmission node starts transmission, a channel occupancy time (COT) cannot exceed the MCOT.

Commonly used LBT categories may be classified into category 1, category 2, and category 4. Category 1 LBT means that a sending node does not perform LBT, that is, there is no LBT or immediate transmission is performed. Category 2 LBT is one-shot LBT, that is, the node performs LBT once before transmission. If the channel is idle, the node performs transmission, or if the channel is busy, the node does not perform transmission. Category 4 LBT is a channel listening mechanism based on back-off. When the transmission node detects that the channel is busy, the transmission node backs off and continues listening until the transmission node detects that the channel is idle. For an NR node (Next-Generation NodeB (gNB)), category 2 LBT is applied to a physical downlink shared channel (PDSCH) without a demodulation reference signal (DMRS), and category 4 LBT is applied to a PDSCH, a physical downlink control channel (PDCCH), and an enhanced physical downlink control channel (ePDCCH). For a terminal, category 4 LBT corresponds to a type 1 uplink channel access procedure (type 1 UL channel access procedure), and category 2 LBT corresponds to a type 2 uplink channel access procedure (type 2UL channel access procedure).

Equipment that performs LBT includes frame based equipment (FBE) and load based equipment (LBE).

The FBE means that a period structure is used for transmission/reception timing of the equipment, and the period is a fixed frame period (FFP). An FBE node uses an LBT-based channel access mechanism to occupy the channel. A node that initiates a transmission sequence including one or more continuous transmissions is referred to as an initiating device, and other nodes are referred to as responding devices. The FBE node may be an initiating device, or a responding device, or support functions of both nodes.

For the LBE, the transmission node may start LBT at any time and can perform transmission only after the transmission node detects that the channel is idle. For the transmission node, there is no fixed listening time, and there is no need to skip when the transmission node detects that the channel is busy. The transmission node can continue listening by backing off (backoff) several enhanced clear channel assessments (eCCA) until an eCCA counter reaches zero.

On an SL, the LBE in the unlicensed band may be used for channel access and information transmission.

### II. NR SL Resource Allocation Mode

NR vehicle-to-everything (NR V2X) supports two resource allocation modes: a scheduled resource allocation mode and an autonomous resource selection mode. The scheduled resource allocation mode is usually referred to as mode 1, and the autonomous resource selection mode is usually referred to as mode 2. In the scheduled resource allocation mode, a resource is allocated to each UE under control of a network-side device. In the autonomous resource selection mode, the UE autonomously selects a resource.

In mode 1, a base station may schedule or activate an NR SL resource for a user by using downlink control information (DCI), and a format of this SL DCI is DCI format 3-0. In mode 1, the base station may activate an LTE SL resource for a user by using another DCI format 3-1.

Mode 2 may be further divided into several sub modes:

In mode 2d, a scheduling terminal (scheduling UE) or a header terminal (header UE) may schedule SL transmission of another terminal.

In mode 2b, terminal A may send assistance information to terminal B to assist terminal B in SL transmission.

In mode 2c, a terminal obtains persistently or semi-persistently paired SL resources for transmission.

### III. Sidelink Hybrid Automatic Repeat Request (Sidelink HARQ) Information Reporting

To improve reliability and resource utilization of data transmission on a sidelink, a HARQ feedback mechanism is also introduced into a sidelink technology. After receiving a physical sidelink control channel (PSCCH) and/or a physical sidelink shared channel (PSSCH), a sidelink receiving user feeds back sidelink hybrid automatic repeat request acknowledgement (sidelink HARQ-ACK) information on a physical sidelink feedback channel (PSFCH) corresponding to the PSCCH and/or the PSSCH, to indicate whether sidelink data is successful or unsuccessful. After receiving the sidelink HARQ-ACK information on the sidelink, a sidelink sending user can know whether the previous transmission has succeeded or failed. It should be noted that a sidelink user may be a sending user or a receiving user, that is, the same user can receive or send separately in different time or frequency domains.

A sidelink data packet may be transmitted on a sidelink between users. Therefore, a control node may be unable to directly know whether the transmission of the sidelink data packet is successful, and a user needs to send sidelink HARQ ACK information (such as a sidelink acknowledgement (sidelink ACK) or a sidelink negative acknowledgement (sidelink NACK)) to the control node, so that the control node can further determine whether the transmission on the sidelink is successful. In mode 1, the user reports SL HARQ information to the control node by using an uplink resource: a physical uplink control channel (PUCCH) or a physical uplink shared channel (PUSCH).

SL HARQ information reporting supports reporting in a form of a codebook. One uplink resource for SL HARQ information reporting may be associated with one or more PSFCH resources, and a priority of the PSFCH is related to other corresponding SL transmission priorities. However, in some special cases, a receive end does not perform HARQ feedback or a transmit end does not detect a PSFCH, but SL HARQ information still exists.

A method for processing sidelink transmission in an unlicensed band according to embodiments of this application is hereinafter described in detail by using some embodiments and application scenarios thereof with reference to the accompanying drawings.

As shown in FIG. 2, an embodiment of this application provides a method for processing sidelink transmission in an unlicensed band. As shown in FIG. 2, the method for processing sidelink transmission in an unlicensed band includes the following steps.

Step 201: A first terminal obtains first information, where the first information includes at least one of first preset information and second preset information, and the first preset information and/or the second preset information includes at least one of monitoring information and information of a preset resource.

Step 202: The first terminal determines whether to perform a first behavior or whether a first behavior needs to be performed, where the first behavior includes at least one of: monitoring a first resource object according to the first information and using the first resource object according to the first information, where
in a case that a first preset condition is met, the first terminal determines to perform the first behavior or that the first behavior needs to be performed, and the first preset condition includes at least one of the following: the first terminal belongs to M terminals that include at least part of terminals associated with the first preset information, and the first terminal does not belong to N terminals that include at least part of terminals associated with the second preset information, where both M and N are positive integers.

In this embodiment of this application, the first resource object may be understood as a resource, a channel in which a resource is located, or a carrier in which a resource is located.

In this embodiment of this application, the foregoing monitoring of the first resource object and/or a second resource object may also be interpreted as attempting to access a corresponding channel, or interpreted as performing channel access.

It should be understood that in a case that the first preset condition is not met, the first terminal determines that the first terminal cannot monitor or does not need to monitor the first resource object according to the first information and/or cannot use or does not need to use the first resource object according to the first information. That the first terminal cannot monitor or does not need to monitor the first resource object according to the first information may be understood as: the first terminal cannot monitor or does not need to monitor the first resource object, or the first terminal cannot monitor or does not need to monitor the first resource object in a monitoring mode corresponding to the first information, but can monitor the first resource object in other modes.

In some embodiments, monitoring the first resource object may be understood as attempting to monitor the first resource object, or to monitor whether the first resource object is idle or busy.

It should be understood that after obtaining the first information, the terminal determines, according to the first information, whether to perform the first behavior or whether the first behavior needs to be performed, so that any one or at least part of terminals obtaining the first information can all perform or need to perform the first behavior. In this way, the terminal can autonomously determine whether to monitor the first resource object according to the first information and/or use the first resource object according to the first information, thereby increasing autonomous selection behaviors of the terminal, further avoiding incorrect scheduling by a network-side device, and improving reliability of SL transmission performed by the terminal in the unlicensed band.

It should be noted that in some embodiments, in a case that the first information includes the first preset information, the first preset condition may include that the first terminal belongs to the M terminals; or in a case that the first information includes the second preset information, the first preset condition may include that the first terminal does not belong to the N terminals.

In this embodiment of this application, the first terminal obtains the first information, and determines whether to perform the first behavior or whether the first behavior needs to be performed, where the first behavior includes at least one of: monitoring the first resource object according to the first information and using the first resource object according to the first information. In this way, the terminal can autonomously determine whether to monitor the first resource object according to the first information and/or use the first resource object according to the first information, thereby increasing autonomous selection behaviors of the terminal, further avoiding incorrect scheduling by the network-side device, and improving reliability of SL transmission performed by the terminal in the unlicensed band.

In some embodiments, the first preset information is associated with at least one first identifier, the second preset information is associated with at least one second identifier, and the method further includes at least one of the following:
when the first terminal meets a first correspondence, the first terminal determines that the first terminal does not meet the first preset condition; and
when the first terminal meets a second correspondence, the first terminal determines that the first terminal meets the first preset condition, where
the first correspondence includes at least one of the following:
the first terminal does not correspond to any one of the at least one first identifier;
the first terminal does not correspond to a preset first identifier of the at least one first identifier; and
the first terminal corresponds to the second identifier; and
the second correspondence includes at least one of the following:
the first terminal does not correspond to any one of the at least one second identifier;
the first terminal does not correspond to a preset second identifier of the at least one second identifier; and
the first terminal corresponds to the first identifier.

In this embodiment of this application, a subgroup identifier may also be understood as a subset identifier (sub set id).

In some embodiments, if the first terminal obtains the first information, but the first terminal does not correspond to any first identifier associated with the first preset information, or does not correspond to the preset first identifier, or corresponds to the second identifier, the first terminal is allowed not to monitor whether the channel is idle/busy, or is allowed not to monitor, according to the first information, whether the channel is idle/busy.

In some embodiments, if the first terminal obtains the first information, but the first terminal does not correspond to any second identifier associated with the second preset information, or does not correspond to the preset second identifier, or corresponds to the first identifier, the first terminal can monitor or needs to monitor whether the channel is idle/busy, or can monitor, according to the preset information, whether the channel is idle/busy.

In some embodiments, the first identifier includes at least one of the following: a source identifier (source id), a destination identifier (destination id), an identifier corresponding to a terminal group (UE group), an identifier of a member in a group, an identifier corresponding to a terminal pair (UE pair), an identifier corresponding to a service, an identifier corresponding to a profile, an identifier of a quality of service (QOS) flow, an identifier of a resource pool, a carrier identifier, an identifier of a bandwidth part (BWP), an identifier of a subgroup (subgroup id) to which a terminal belongs, an identifier of a resource block (RB) set, an identifier of a channel, an identifier of a subchannel, an index of the first preset information, an index of the first preset information, and a radio network temporary identifier (RNTI); and/or
the second identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the second preset information, an index of the second preset information, and a radio network temporary identifier.

For example, when the first identifier is the destination identifier, for groupcast, UE corresponding to a destination can monitor the first resource object according to the first preset information.

In some embodiments, when the first identifier is the index of the first preset information, it is assumed that the first terminal is configured to be associated with the first preset information with index=1, so that the first terminal performs monitoring according to the first preset information with index=1.

In some embodiments, when the first identifier is the index of the first preset information, it is assumed that the first terminal is configured to be associated with the first preset information with index i, so that the first terminal performs monitoring according to the first preset information with index i.

In some embodiments, when the first identifier and the second identifier are RNTIs, the RNTIs may be terminal-specific RNTIs or common RNTIs.

For example, when the second identifier is the destination identifier, for groupcast, UE corresponding to a destination may determine, according to the second preset information, that the UE does not need to monitor the first resource object.

In some embodiments, when the second identifier is the index of the second preset information, it is assumed that the first terminal is configured to be associated with the second preset information with index=2, so that the first terminal determines, according to the second preset information with index=2 that the first terminal does not need to monitor the first resource object.

In some embodiments, when the second identifier is the index of the second preset information, it is assumed that the first terminal is configured to be associated with the second preset information with index j, so that the first terminal determines, according to the second preset information with index j, that the first terminal does not need to monitor the first resource object.

It should be noted that the foregoing first identifier and/or second identifier may be configured by the network-side device for the first terminal, or may be derived by the first terminal according to a rule, agreed in a protocol, or preconfigured.

In some embodiments, the first preset information meets at least one of the following:
indicating that the M terminals are to monitor the first resource object in a first monitoring mode;
indicating that the M terminals are to use the first resource object;
indicating that the M terminals are to monitor the first resource object;
the first preset information includes terminal identifiers corresponding to the M terminals; and
the first preset information is associated with at least one first identifier, and the M terminals are at least part of terminals corresponding to the first identifier.

In some embodiments, the first monitoring mode may be LBT of type 1, LBT based on back-off, or LBT based on a counter. Indicating that the M terminals are to use the first resource object may be understood as indicating that the M terminals are to use the first resource object for transmission. Indicating that the M terminals are to monitor the first resource object may be understood as indicating that the M terminals are to monitor the first resource object in any monitoring mode. In this case, monitoring modes used by part of the M terminals may be different or determined in another manner.

In this embodiment of this application, that the first preset information includes terminal identifiers corresponding to the M terminals may be understood as: the first preset information directly indicates the M terminals that can monitor or need to monitor the first resource object, and the first preset information may also indicate other terminals than the M terminals. In addition, that the first preset information is associated with at least one first identifier may be understood as: the first preset information indirectly indicates the M terminals that can monitor or need to monitor the first resource object. In other words, in this embodiment of this application, the first preset information may be used to directly or indirectly indicate that any one or at least part of the terminals obtaining the first information can all monitor or need to monitor the channel.

In some embodiments, the second preset information meets any one of the following:
indicating that the N terminals are not to monitor the first resource object in a first monitoring mode;
indicating that the first resource object is not to be used;
indicating that the N terminals are not to monitor the first resource object;
the second preset information includes terminal identifiers corresponding to the N terminals; and
the second preset information is associated with at least one second identifier, and the N terminals are at least part of terminals corresponding to the second identifier.

It should be understood that in this embodiment of this application, when the terminal receiving the second preset information is a terminal corresponding to the second preset information, the terminal is allowed not to monitor the first resource object. Not monitoring the first resource object may be understood as not monitoring the first resource object in the first monitoring mode or not monitoring at all.

In some embodiments, indicating that the N terminals are not to use the first resource object may be understood as indicating that the N terminals are not to use the first resource object for transmission. Indicating that the N terminals are not to monitor the first resource object may be understood as indicating that the N terminals are not to monitor the first resource object at all.

In this embodiment of this application, that the second preset information includes terminal identifiers corresponding to the N terminals may be understood as: the second preset information directly indicates the N terminals that cannot monitor or do not need to monitor the first resource object, and the first preset information may also indicate other terminals than the N terminals. In addition, that the second preset information is associated with at least one second identifier may be understood as: the second preset information indirectly indicates the N terminals that cannot monitor or do not need to monitor the first resource object. In other words, in this embodiment of this application, the second preset information may be used to directly or indirectly indicate that any one or at least part of the terminals obtaining the first information are all disallowed to monitor or do not need to monitor the channel.

In some embodiments, that a first terminal obtains first information includes:
the first terminal receives the first information from the network-side device, where
the first information is carried by at least one of the following: downlink control information DCI, radio resource control (RRC) signaling, and media access control (MAC) signaling.

In this embodiment of this application, the MAC signaling may be a MAC control element (CE). In the following description, it is assumed that the network-side device sends the first information by using the DCI.

In some embodiments, the DCI may be scrambled by a preset RNTI, where the preset RNTI may be at least part of the foregoing first identifier. For example, the DCI is common DCI, and when an RNTI related to a terminal group is used for scrambling, only terminals in the terminal group can decode the DCI.

In some embodiments, the DCI may carry a plurality of pieces of first preset information and/or second preset information, and the network-side device configures the terminal to be associated with a specific piece or specific pieces of preset information (that is, the first preset information and/or the second preset information). For example, if the DCI is common DCI and is scrambled by a common RNTI, the terminal needs to further determine whether there is preset information corresponding to the terminal after decoding the DCI.

Further, in some embodiments, the method further includes:
the first terminal receives first indication information from the network-side device, where the first indication information is used to indicate any one of the following: activating the first information, deactivating the first information, using the first information, not using the first information, and stopping using the first information.

In this embodiment of this application, the network-side device may configure one or more pieces of first information for at least one terminal, and further activate or deactivate the first information by using the first indication information, that is, using the first information to indicate that the terminal can monitor or is allowed not to monitor the first resource object according to the first information. For example, the network-side device configures different resources (the first preset information indicates these resources) for terminals in a group by using RRC signaling (which carries the first indication information), and sends DCI to activate these resources, that is, the terminal may start monitoring these resources or the first resource object or may directly use these resources or the first resource object.

In some embodiments, the network-side device may configure different resources (preset information indicates these resources) for UE in a group using RRC signaling, and send DCI (second indication information) to deactivate these resources, that is, the UE may start not to monitor these resources/channels, or may directly not use these resources/channels.

In some embodiments, the M terminals meet at least one of the following:
being a header terminal in a group;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, where the target identifier is a terminal identifier, a terminal number, or a terminal index;
corresponding to a result of preset processing of the first identifier; and
being a terminal that receives second indication information from the network-side device, where the second indication information is used to indicate that the terminal can monitor or needs to monitor the first resource object, where
the third identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier.

In this embodiment of this application, the preset processing may be modulo processing. For example, if the first identifier is a group identifier and a result of the group identifier modulo the preset value Q is v, terminals corresponding to v (that is, the M terminals) can monitor or need to monitor the first resource object.

In some embodiments, the second indication information may also be understood as or replaced with being used to indicate that the terminal can monitor or needs to monitor the resource object. For example, the network-side device indicates, by using additional signaling (for indicating that the UE can monitor or needs to monitor the first resource object or other resource objects), that the UE needs to perform monitoring. The UE performs monitoring only after obtaining the first information; and UE not instructed by additional signaling may not perform monitoring even if the UE has obtained the first information.

In some embodiments, the first behavior meets either of the following:
a monitoring mode of the first resource object is a first monitoring mode; and
the monitoring mode of the first resource object is determined based on an indication from the network-side device and/or based on a fourth identifier corresponding to the first terminal, where
the fourth identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier.

In this embodiment of this application, the M terminals can monitor the first resource object in a first monitoring mode; or a used monitoring mode meets at least one of the following:
monitoring mode type information configured/indicated by the network-side device; and
being associated with the fourth identifier corresponding to the terminal.

For example, both terminal 1 and terminal 2 correspond to the first identifier, so that both terminal 1 and terminal 2 monitor the channel. Further, a subgroup identifier (that is, the fourth identifier) corresponding to terminal 1 is 1, and a subgroup identifier corresponding to terminal 2 is 2, so that terminal 1 can determine a monitoring mode of terminal 1 based on subgroup identifier 1, and that terminal 2 can determine a monitoring mode of terminal 2 based on subgroup identifier 2.

It should be noted that the fourth identifier and the first identifier may correspond to a same item or different items.

In some embodiments, when the M terminals include all the terminals associated with the first preset information, the first terminal may be understood as any terminal associated with the first preset information; and when the N terminals include all the terminals associated with the second preset information, the first terminal may be understood as any terminal except the terminals associated with the second preset information. In some embodiments, among a plurality of terminals obtaining the first information, a terminal belonging to the M terminals and/or not belonging to the N terminals may be referred to as a target terminal, and the target terminal may also be understood as any one or at least part of the terminals obtaining the first information.

In some embodiments, after any one or at least part of the terminals obtaining the first information perform monitoring, if terminal A (which may include one or more terminals) finds that the first resource object is idle or available, or successfully obtains the first resource object, any one or at least part of other terminals may have behavior 1 and/or behavior 2. The other terminals may be terminals other than terminal A among the foregoing target terminals, and may also be understood as terminals corresponding to the same identifier A as terminal A. A range of the identifier A is the same as that of the first identifier, and the identifier A and the first identifier may correspond to a same item or different items.

In some embodiments, behavior 1 and/or behavior 2 can be performed when any one or at least part of the other terminals receive an SL signal/channel sent by terminal A.

In some embodiments, behavior 1 includes at least one of the following:
considering that the first resource object is occupied by terminal A;
considering that the first resource object is occupied by an SL system; and
considering that the first resource object is occupied by at least part of the terminals corresponding to the identifier A.

In some embodiments, behavior 2 includes:
determining that the second resource object can or needs to be monitored in a second monitoring mode, where the second resource object at least partially overlaps the first resource object.

In some embodiments, the second monitoring mode is different from the first monitoring mode. In some embodiments, a monitoring duration of the second monitoring mode is shorter than that of the first monitoring mode. For example, the second monitoring mode may include a monitoring mode of type 2, type 2a, type 2b, type 2d, type 2c, or the like.

In this embodiment of this application, the other terminals also need to meet at least one of the following:
needing to send a message or response to terminal A;
being a member terminal in a terminal group to which terminal A belongs;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, where the target identifier is a terminal identifier, a terminal number, or a terminal index;
corresponding to a result of preset processing of the first identifier;
being a terminal that receives first indication information from the network-side device, where the first indication information is used to indicate any one of the following: activating the first information, deactivating the first information, using the first information, not using the first information, and stopping using the first information; and
being a terminal that receives fourth indication information from the network-side device, where the fourth indication information is used to indicate that the terminal can monitor or needs to monitor the second resource object.

In this embodiment of this application, the network-side device may indicate which terminals can perform transmission on obtained resources (for example, within an obtained COT). In some embodiments, the network-side device may indicate related identifiers of these terminals, for example, by using the source ID or the destination ID, to indicate that the corresponding terminals can perform transmission within the obtained COT. In some embodiments, the network-side device may notify terminal A which terminals can perform transmission on the resources obtained by terminal A (for example, within the obtained COT) and which terminals can monitor or need to monitor the resources obtained by terminal A. In some embodiments, the network-side device may indicate the related identifiers of these terminals to terminal A.

In some embodiments, terminal A and a terminal indicated by a base station are mode-1 terminals, or terminals using a mode scheduled by a base station.

In some embodiments, terminal A may consider that any one or at least part of the other terminals can use or need to use the second resource object, or consider that any one or at least part of the other terminals can monitor or need to monitor the second resource object.

Further, terminal A may indicate that at least part of the other terminals corresponding to the same identifier A as terminal A can use or need to use the second resource object, or indicate that the second resource object can be monitored or needs to be monitored.

For example, terminal A instructs terminal B to share the COT obtained by terminal A. For another example, terminal A may instruct terminal B to perform transmission within the COT obtained by terminal A. For another example, terminal A instructs terminal B to monitor the second resource object in the second monitoring mode.

Further, at least part of the other terminals can use or need to use the second resource object, or can monitor or need to monitor the second resource object. For example, the other terminals automatically consider by default that they can use the COT of terminal A, or the other terminals consider that they need to monitor the channel.

It should be noted that in this embodiment of this application, after terminal A seizes the resource object, the other terminals can directly use the resource object, or the second monitoring mode is provided to monitor the second resource object. In this way, a success rate of terminal access can be increased, an effect of power saving can be achieved, and resource utilization can be improved.

In some embodiments, a terminal that can use the second resource object as indicated by terminal A and that corresponds to the same identifier A as terminal A can use the second resource object for transmission. For example, terminal B and terminal A are in a terminal group, and terminal A obtains the first resource object and indicates that terminal B can share the COT. In this case, terminal B can perform transmission within the COT.

In some embodiments, the other terminals corresponding to the same identifier A as terminal A may also have the following behaviors:
monitoring the second resource object in the second monitoring mode, and further considering that they can also use the second resource object after successful monitoring.

The used monitoring mode is related to at least one of the following: 1. the monitoring mode type information configured/indicated by the network-side device; and 2. an identifier corresponding to the terminal.

The identifier corresponding to the terminal may be the same as a range of the first identifier or the second identifier, but may correspond to a same item or different items.

It should be noted that the first terminal may belong to different terminals (terminal A or other terminals), corresponding to different behaviors, as described in detail below.

In some embodiments, after the first terminal determines whether to perform the first behavior or whether the first behavior needs to be performed, the method further includes:
in a case that the first terminal knows target information, the first terminal performs a second behavior, where
the target information includes at least one of the following: a second terminal determines that the first resource object is idle or available; the second terminal successfully accesses or obtains the first resource object; and the second terminal uses the first resource object;
the second behavior includes at least one of the following: determining that the first resource object is occupied by the second terminal; determining that the first resource object is occupied by a sidelink system; determining that the first resource object is occupied by at least part of terminals corresponding to a fifth identifier, where the at least part of the terminals corresponding to the fifth identifier include the second terminal; and determining second information in a case that the first terminal belongs to the at least part of the terminals corresponding to the fifth identifier; and
the second information includes at least one of the following: a second resource object, where the second resource object at least partially overlaps the first resource object; a requirement for monitoring the second resource object; a need to monitor the second resource object; and use of the second resource object.

In this embodiment of this application, the first terminal may be understood as a terminal among the at least part of the other terminals or any one of the other terminals. The second terminal may be understood as terminal A.

That third indication information indicates the second resource object may be understood as: the second terminal indicates a COT to the first terminal, and after the first terminal receives the indication of the COT, the first terminal considers by default that the first terminal can perform transmission within the COT. When the third indication information indicates the monitoring mode of the first terminal, the monitoring mode may be of type 2, that is, it indicates that the first terminal monitors the second resource object in a monitoring mode of type 2.

In some embodiments, the second behavior meets either of the following:
a monitoring mode of the second resource object is a second monitoring mode; and
the monitoring mode of the second resource object is determined based on an indication from the network-side device and/or based on a fourth identifier corresponding to the first terminal, where
the fourth identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier.

In some embodiments, the first terminal meets at least one of the following:
needing to send a message or response to the second terminal;
being a member terminal in a terminal group to which the second terminal belongs;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, where the target identifier is a terminal identifier, a terminal number, or a terminal index;
corresponding to a result of preset processing of the first identifier;
being a terminal that receives first indication information from the network-side device, where the first indication information is used to indicate any one of the following: activating the first information, deactivating the first information, using the first information, not using the first information, and stopping using the first information; and
being a terminal that receives fourth indication information from the network-side device, where the fourth indication information is used to indicate that the terminal can monitor or needs to monitor the second resource object.

In some embodiments, after the first terminal determines whether to perform the first behavior or whether the first behavior needs to be performed, the method further includes:
in a case that a second preset condition is met, the first terminal performs a third behavior, where
the third behavior includes at least one of the following: determining that a third terminal can monitor or needs to monitor a second resource object, where the second resource object at least partially overlaps the first resource object; and being allowed to or needing to use the second resource object;
the second preset condition includes at least one of the following: the first terminal finds that the first resource object is idle or available; the first terminal successfully obtains the first resource object; and the first terminal uses the first resource object; and
the third terminal is at least part of terminals corresponding to a same fourth identifier as the first terminal, where the fourth identifier is a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier.

In this embodiment of this application, the first terminal may be understood as terminal A, and the third terminal may be understood as a terminal among the at least part of the other terminals or any one of the other terminals.

In some embodiments, after the first terminal determines that the third terminal can monitor or needs to monitor the second resource object in the case that the second preset condition is met, the method further includes:
the first terminal sends fifth indication information to the third terminal, where the fifth indication information is used to indicate at least one of the following: the third terminal can monitor the second resource object; the third terminal needs to monitor the second resource object; the third terminal uses the second resource object; the second resource object or a monitoring mode of the third terminal.

In this embodiment of this application, because the third terminal can monitor or using the second resource object only after the first terminal instructs the third terminal, pertinence of transmission can be improved, and the other terminals can be prevented from maliciously using the second resource object, thereby improving reliability of transmission.

In some embodiments, the third terminal meets at least one of the following:
needing to send a message or response to the first terminal;
being a member terminal in a terminal group to which the first terminal belongs;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, where the target identifier is a terminal identifier, a terminal number, or a terminal index;
corresponding to a result of preset processing of the first identifier;
being a terminal that receives first indication information from the network-side device, where the first indication information is used to indicate any one of the following: activating the first information, deactivating the first information, using the first information, not using the first information, and stopping using the first information; and
being a terminal that receives sixth indication information from the network-side device, where the sixth indication information is used to indicate that the third terminal can monitor or needs to monitor the second resource object.

In some embodiments, the method further includes:
the first terminal sends third information to the network-side device, where the third information includes at least one of the following:
an available channel occupancy time obtained by the first terminal;
fourth indication information about whether the first resource object is successfully obtained or used;
a monitoring mode for monitoring the first resource object;
terminal information of the first terminal;
hybrid automatic repeat request acknowledgement HARQ-ACK information corresponding to SL transmission of the first terminal; and
hybrid automatic repeat request acknowledgement HARQ-ACK information corresponding to an SL transmission failure of the first terminal.

In this embodiment of this application, the available channel occupancy time obtained by the first terminal may be indicated by at least one of the following: a COT type, a COT priority, a COT limit (such as a maximum COT length and a minimum COT length), a COT start point, a COT length, and a COT end point. Because the terminal feeds back the third information to the network-side device, the network-side device can know a channel access status or a resource status of the terminal, thereby assisting the network-side device in scheduling the terminal, avoiding incorrect scheduling, and further improving reliability of SL transmission.

In some embodiments, the terminal information of the first terminal may include identity information of the terminal, to notify the network-side device which terminal has obtained the COT.

In some embodiments, a design may be that if the terminal sends the third information to the network-side device, it means that the terminal or some terminals have successfully obtained the first resource object, or means that the terminal or some terminals have not successfully obtained the channel.

In some embodiments, a design may be that if the terminal does not send the third information to the network-side device, it means that the terminal or some terminals have successfully obtained the first resource object.

In some embodiments, the monitoring information includes at least one of the following:
the number of monitoring or access (such as LBT) attempts, or the maximum number of monitoring or access (such as LBT) attempts;
the number of monitoring or access (such as LBT) failures, or the maximum number of monitoring or access (such as LBT) failures; and
a monitoring or access (such as LBT) success interval, a maximum monitoring or access (such as LBT) success interval, or a minimum monitoring or access (such as LBT) success interval.

In this embodiment of this application, the number of LBT attempts may be understood as the number of CCAs, the number of eCCAs, or a value of an LBT counter, and the maximum number of LBT attempts may be understood as the maximum number of CCAs, the maximum number of eCCAs, or a maximum value of the LBT counter.

The failures may be understood as cumulative failures or consistent failures. The number of LBT failures may be understood as the number of CCA failures, the number of eCCA failures, or the number of times that the LBT counter remains unchanged, and the maximum number of LBT failures may be understood as the maximum number of CCA failures, the maximum number of eCCA failures, or the maximum number of times that the LBT counter remains unchanged.

The success interval may be understood as a cumulative success interval or a continuous success interval. For example, if an interval value is 2, the monitoring information may include an interval or a maximum interval between two successful CCAs or two successful eCCAs. In some embodiments, the monitoring information may include an interval between two times that the LBT counter is reduced, the number of times that the counter remains unchanged, the maximum interval or minimum interval between two times that the LBT counter is reduced, or the maximum number of times or the minimum number of times that the counter remains unchanged.

In some embodiments, the preset resource includes at least one of the following:
a time period;
a time resource corresponding to a timer;
the number of monitoring or access (such as LBT) attempts, or a resource corresponding to the maximum number of monitoring or access (such as LBT) attempts;
the number of monitoring or access (such as LBT) failures, or a resource corresponding to the maximum number of monitoring or access (such as LBT) failures; and
a monitoring or access (such as LBT) success interval, or a resource corresponding to a maximum monitoring or access (such as LBT) success interval.

The time period may be understood as a time period of the preset resource.

For the timer, it may be considered that a time resource corresponding to the timer during running is a preset resource, or that a time resource corresponding to the timer after expiry is a preset resource.

In some embodiments, the information of the preset resource includes at least one of the following:
duration information;
time point information;
offset information; and
reference time point information.

The duration information may include a time period or a timer duration. The time point information may include a time period, or a start point, an end point, a start time point, a stop time point, a pause time point, or a restart time point of a timer. The offset information may include an offset of the time period or the time point when the timer is started or ended or paused or restarted relative to a reference time point. The reference time point information may include direct frame number (DFN) 0, system frame number (SFN) 0, slot 0, subframe 0, or symbol 0.

In some embodiments, the monitoring a first resource object according to the first information includes:
monitoring whether the preset resource is idle or busy; and
monitoring whether the first resource object is idle or busy within a range of the preset resource.

In some embodiments, the preset resource includes at least two resource subsets, each resource subset is associated with at least one terminal, terminal group, terminal pair, or sixth identifier, and that the first terminal determines whether to perform a first behavior or whether a first behavior needs to be performed includes:
the first terminal determines whether to perform the first behavior in a resource subset associated with the first terminal or whether the first behavior needs to be performed in a resource subset associated with the first terminal.

For example, in some embodiments, the preset resource includes a plurality of bands, RB sets, carriers, or resource pools, and the identifiers corresponding to the terminals may be associated with different bands, RB sets, carriers, or resource pools respectively, so that different terminals may monitor different bands, RB sets, carriers, or resource pools.

For example, in some embodiments, the preset resource includes a plurality of bands, RB sets, carriers, or resource pools, and the identifiers corresponding to the terminals may be associated with different bands, RB sets, carriers, or resource pools respectively, so that different terminals may use different bands, RB sets, carriers, or resource pools.

It should be noted that in the process of monitoring the first resource object according to the first information, if the number limit or interval limit corresponding to monitoring or access (such as LBT) is reached or exceeded, the terminal can no longer perform monitoring or access. Further, target feedback information may be fed back to the network-side device, and the target feedback information is used to indicate at least one of the following: monitoring or access (such as LBT) of the terminal has reached or exceeded the corresponding number limit or interval limit, and the terminal no longer performs monitoring or access.

For better understanding this application, some specific examples are used for description.

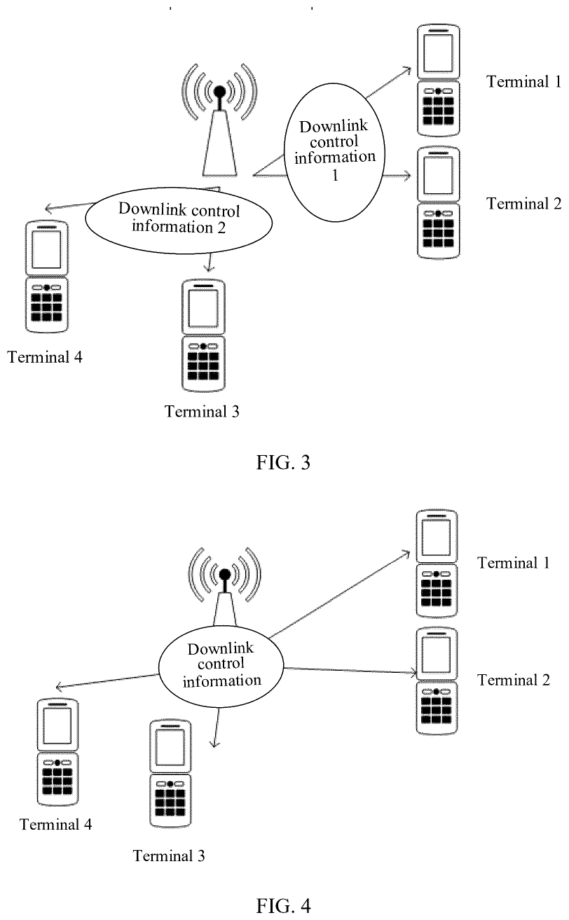

In some embodiments, as shown in FIG. 3, terminal 1 and terminal 2 correspond to a same group, and a destination ID of the group is 1; terminal 3 and terminal 4 correspond to a same group, and a destination ID of the group is 2; RNTI 1 is associated with destination ID 1, and RNTI 2 is associated with destination ID 2; and a base station sends two pieces of DCI scrambled with RNTI 1 and RNTI 2 respectively. After decoding DCI 1, terminal 1 and terminal 2 obtain preset resource information indicated by DCI 1, and perform monitoring. Terminal 1 performs LBT and successfully obtains a COT. After decoding DCI 2, terminal 3 and terminal 4 obtain preset resource information indicated by DCI 2, and perform monitoring. Terminal 3 performs LBT and successfully obtains a COT.

In some embodiments, as shown in FIG. 4, terminal 1 and terminal 2 correspond to a same group, and a destination ID of the group is 1; terminal 3 and terminal 4 correspond to a same group, and a destination ID of the group is 2; and a base station sends one piece of DCI scrambled with a common RNTI, where the DCI indicates information of time period 0, and time period 1 to time period n. The base station configures terminal 1 and terminal 2 to be associated with time period 0 indicated by the DCI. Therefore, after decoding the DCI, terminal 1 and terminal 2 obtain information of time period 0 indicated by the DCI, and perform monitoring. The base station configures terminal 3 and terminal 4 to be associated with time period n indicated by the DCI. Therefore, after decoding the DCI, terminal 3 and terminal 4 obtain information of time period n indicated by the DCI, and perform monitoring.

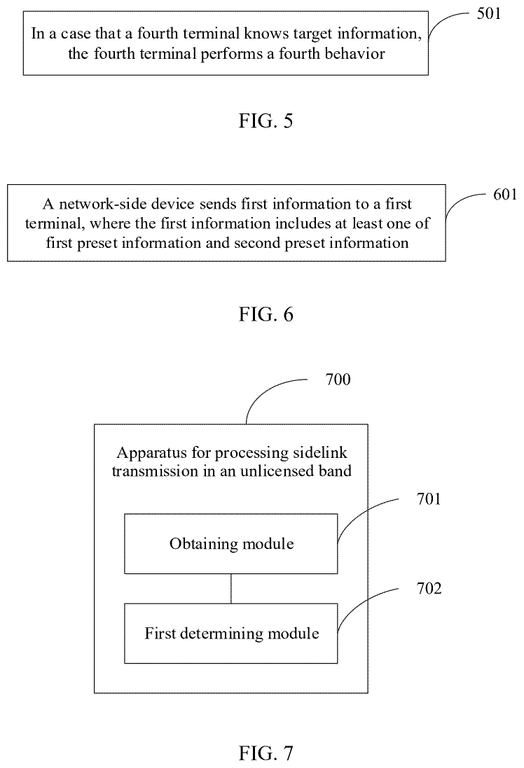

Referring to FIG. 5, an embodiment of this application further provides a method for processing sidelink transmission in an unlicensed band. As shown in FIG. 5, the method for processing sidelink transmission in an unlicensed band may include the following step.

Step 501: In a case that a fourth terminal knows target information, the fourth terminal performs a fourth behavior, where
the target information includes at least one of the following: a second terminal determines that a first resource object is idle or available; the second terminal successfully accesses or obtains the first resource object; and the second terminal uses the first resource object;
the fourth behavior includes at least one of the following: determining that the first resource object is occupied by the second terminal; determining that the first resource object is occupied by a sidelink system; determining that the first resource object is occupied by at least part of terminals corresponding to a fifth identifier, where the at least part of the terminals corresponding to the fifth identifier include the second terminal; and determining second information in a case that the fourth terminal belongs to the at least part of the terminals corresponding to the fifth identifier; and
the second information includes at least one of the following: a second resource object, where the second resource object at least partially overlaps the first resource object; a requirement for monitoring the second resource object; a need to monitor the second resource object; and use of the second resource object.

In this embodiment of this application, the fourth terminal may be understood as other terminals in the foregoing embodiment, and the second terminal may be understood as terminal A. A difference between the fourth terminal and the first terminal is that the fourth terminal has not obtained the first information, while the first terminal has obtained the first information.

In some embodiments, the determining second information in a case that the fourth terminal belongs to the at least part of the terminals corresponding to the fifth identifier includes:
determining the second information in a case that the fourth terminal belongs to the at least part of the terminals corresponding to the fifth identifier and receives seventh indication information sent by the second terminal, where
the seventh indication information is used to indicate at least one of the following: the second resource object; the fourth terminal can monitor the second resource object; the fourth terminal needs to monitor the second resource object; the fourth terminal uses the second resource object; the second resource object or a monitoring mode of the fourth terminal.

In some embodiments, the fourth behavior meets either of the following:
a monitoring mode of the second resource object is a second monitoring mode; and
the monitoring mode of the second resource object is determined based on an indication from a network-side device and/or based on a fourth identifier corresponding to the fourth terminal, where
the fourth identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of first preset information, an index of the first preset information, and a radio network temporary identifier.

In some embodiments, the fourth terminal meets at least one of the following:
needing to send a message or response to the second terminal;
being a member terminal in a terminal group to which the second terminal belongs;
corresponding to a preset third identifier;
corresponding to a first identifier associated with first preset information;
not corresponding to a second identifier associated with second preset information;
being a terminal whose target identifier is largest, whose target identifier is smallest, or whose target identifier is a first preset value among terminals corresponding to the first identifier, where the target identifier is a terminal identifier, a terminal number, or a terminal index;
corresponding to a result of preset processing of the first identifier; and
being a terminal that receives eighth indication information from a network-side device, where the eighth indication information is used to indicate that the terminal can monitor or needs to monitor the second resource object, where
the first preset information and/or the second preset information includes at least one of monitoring information and information of a preset resource.

Referring to FIG. 6, an embodiment of this application further provides a method for processing sidelink transmission in an unlicensed band. As shown in FIG. 6, the method for processing sidelink transmission in an unlicensed band may include the following step.

Step 601: A network-side device sends first information to a first terminal, where the first information includes at least one of first preset information and second preset information, and the first preset information and/or the second preset information includes at least one of monitoring information and information of a preset resource.

In some embodiments, the first preset information is associated with at least one first identifier, the second preset information is associated with at least one second identifier, and the method further includes at least one of the following:
when the first terminal meets a first correspondence, the first terminal determines that the first terminal does not meet a first preset condition; and
when the first terminal meets a second correspondence, the first terminal determines that the first terminal meets the first preset condition, where
the first correspondence includes at least one of the following:
the first terminal does not correspond to any one of the at least one first identifier;
the first terminal does not correspond to a preset first identifier of the at least one first identifier; and
the first terminal corresponds to the second identifier; and
the second correspondence includes at least one of the following:
the first terminal does not correspond to any one of the at least one second identifier;
the first terminal does not correspond to a preset second identifier of the at least one second identifier; and
the first terminal corresponds to the first identifier.

The first identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier; and/or
the second identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the second preset information, an index of the second preset information, and a radio network temporary identifier.

In some embodiments, the first preset information meets at least one of the following:
indicating that M terminals are to monitor a first resource object in a first monitoring mode, where the M terminals include at least part of terminals associated with the first preset information, and M is a positive integer;
indicating that the M terminals are to use the first resource object;
indicating that the M terminals are to monitor the first resource object;
the first preset information includes terminal identifiers corresponding to the M terminals; and
the first preset information is associated with at least one first identifier, and the M terminals are at least part of terminals corresponding to the first identifier.

In some embodiments, the second preset information meets any one of the following:
indicating that N terminals are not to monitor a first resource object in a first monitoring mode, where the N terminals include at least part of terminals associated with the second preset information, and N is a positive integer;
indicating that the first resource object is not to be used;
indicating that the N terminals are not to monitor the first resource object;
the second preset information includes terminal identifiers corresponding to the N terminals; and
the second preset information is associated with at least one second identifier, and the N terminals are at least part of terminals corresponding to the second identifier.

In some embodiments, the method further includes:
the network-side device sends first indication information, where the first indication information is used to indicate any one of the following: activating the first information, deactivating the first information, using the first information, and stopping using the first information.

In some embodiments, the method further includes:
the network-side device receives third information from the first terminal, where the third information includes at least one of the following:
an available channel occupancy time obtained by the first terminal;
fourth indication information about whether a first resource object is successfully obtained or used;
a monitoring mode for monitoring the first resource object;
terminal information of the first terminal;
hybrid automatic repeat request acknowledgement HARQ-ACK information corresponding to SL transmission of the first terminal; and
hybrid automatic repeat request acknowledgement HARQ-ACK information corresponding to an SL transmission failure of the first terminal.

In some embodiments, the monitoring information includes at least one of the following:
the number of monitoring or access attempts, or the maximum number of monitoring or access attempts;
the number of monitoring or access failures, or the maximum number of monitoring or access failures; and
a monitoring or access success interval, a maximum monitoring or access success interval, or a minimum monitoring or access success interval.

In some embodiments, the preset resource includes at least one of the following:
a time period;
a time resource corresponding to a timer;
the number of monitoring or access attempts, or a resource corresponding to the maximum number of monitoring or access attempts;
the number of monitoring or access failures, or a resource corresponding to the maximum number of monitoring or access failures; and
a monitoring or access success interval, or a resource corresponding to a maximum monitoring or access success interval.

In some embodiments, the information of the preset resource includes at least one of the following:
duration information;
time point information;
offset information; and
reference time point information.

The method for processing sidelink transmission in an unlicensed band according to the embodiments of this embodiment of this application may be performed by an apparatus for processing sidelink transmission in an unlicensed band. An apparatus for processing sidelink transmission in an unlicensed band according to the embodiments of this application is described by assuming that the method for processing sidelink transmission in an unlicensed band is performed by the apparatus for processing sidelink transmission in an unlicensed band in the embodiments of this application.

Referring to FIG. 7, an embodiment of this application provides an apparatus for processing sidelink transmission in an unlicensed band. As shown in FIG. 7, the apparatus 700 for processing sidelink transmission in an unlicensed band includes:
an obtaining module 701, configured to obtain first information, where the first information includes at least one of first preset information and second preset information, and the first preset information and/or the second preset information includes at least one of monitoring information and information of a preset resource; and
a first determining module 702, configured to determine whether to perform a first behavior or whether a first behavior needs to be performed, where the first behavior includes at least one of: monitoring a first resource object according to the first information and using the first resource object according to the first information, where
in a case that a first preset condition is met, the apparatus determines to perform the first behavior or that the first behavior needs to be performed, and the first preset condition includes at least one of the following: the apparatus belongs to M terminals that include at least part of terminals associated with the first preset information, and the apparatus does not belong to N terminals that include at least part of terminals associated with the second preset information, where both M and N are positive integers.

In some embodiments, the first preset information is associated with at least one first identifier, the second preset information is associated with at least one second identifier, and the apparatus further performs at least one of the following:
when the apparatus meets a first correspondence, the apparatus determines that the apparatus does not meet the first preset condition; and
when the apparatus meets a second correspondence, the apparatus determines that the apparatus meets the first preset condition, where
the first correspondence includes at least one of the following:
the apparatus does not correspond to any one of the at least one first identifier;
the apparatus does not correspond to a preset first identifier of the at least one first identifier; and
the apparatus corresponds to the second identifier; and
the second correspondence includes at least one of the following:
the apparatus does not correspond to any one of the at least one second identifier;
the apparatus does not correspond to a preset second identifier of the at least one second identifier; and
the apparatus corresponds to the first identifier.

In some embodiments, the first identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier; and/or
the second identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the second preset information, an index of the second preset information, and a radio network temporary identifier.

In some embodiments, the first preset information meets at least one of the following:
indicating that the M terminals are to monitor the first resource object in a first monitoring mode;
indicating that the M terminals are to use the first resource object;
indicating that the M terminals are to monitor the first resource object;
the first preset information includes terminal identifiers corresponding to the M terminals; and
the first preset information is associated with at least one first identifier, and the M terminals are at least part of terminals corresponding to the first identifier.

In some embodiments, the second preset information meets any one of the following:
indicating that the N terminals are not to monitor the first resource object in a first monitoring mode;
indicating that the first resource object is not to be used;
indicating that the N terminals are not to monitor the first resource object;
the second preset information includes terminal identifiers corresponding to the N terminals; and
the second preset information is associated with at least one second identifier, and the N terminals are at least part of terminals corresponding to the second identifier.

In some embodiments, the obtaining module 701 is configured to receive the first information from a network-side device, where
the first information is carried by at least one of the following: downlink control information DCI, radio resource control RRC signaling, and media access control MAC signaling.

In some embodiments, the apparatus 700 for processing sidelink transmission in an unlicensed band further includes:
a first receiving module, configured to receive first indication information from a network-side device, where the first indication information is used to indicate any one of the following: activating the first information, deactivating the first information, using the first information, not using the first information, and stopping using the first information.

In some embodiments, the M terminals meet at least one of the following:
being a header terminal in a group;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, where the target identifier is a terminal identifier, a terminal number, or a terminal index;
corresponding to a result of preset processing of the first identifier; and
being a terminal that receives second indication information from a network-side device, where the second indication information is used to indicate that the terminal can monitor or needs to monitor the first resource object, where
the third identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier.

In some embodiments, the first behavior meets either of the following:
a monitoring mode of the first resource object is a first monitoring mode; and
the monitoring mode of the first resource object is determined based on an indication from a network-side device and/or based on a fourth identifier corresponding to the apparatus, where
the fourth identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier.

In some embodiments, the apparatus 700 for processing sidelink transmission in an unlicensed band further includes:
a first execution module, configured to perform a second behavior in a case that the apparatus knows target information, where
the target information includes at least one of the following: a second terminal determines that the first resource object is idle or available; the second terminal successfully accesses or obtains the first resource object; and the second terminal uses the first resource object;
the second behavior includes at least one of the following: determining that the first resource object is occupied by the second terminal; determining that the first resource object is occupied by a sidelink system; determining that the first resource object is occupied by at least part of terminals corresponding to a fifth identifier, where the at least part of the terminals corresponding to the fifth identifier include the second terminal; and determining second information in a case that the apparatus belongs to the at least part of the terminals corresponding to the fifth identifier; and
the second information includes at least one of the following: a second resource object, where the second resource object at least partially overlaps the first resource object; a requirement for monitoring the second resource object; a need to monitor the second resource object; and use of the second resource object.

In some embodiments, the determining second information in a case that the apparatus belongs to the at least part of the terminals corresponding to the fifth identifier includes:
determining the second information in a case that the apparatus belongs to the at least part of the terminals corresponding to the fifth identifier and receives third indication information sent by the second terminal, where
the third indication information is used to indicate at least one of the following: the second resource object; the apparatus can monitor the second resource object; the apparatus needs to monitor the second resource object; the apparatus uses the second resource object; the second resource object or a monitoring mode of the apparatus.

In some embodiments, the second behavior meets either of the following:
a monitoring mode of the second resource object is a second monitoring mode; and
the monitoring mode of the second resource object is determined based on an indication from a network-side device and/or based on a fourth identifier corresponding to the apparatus, where
the fourth identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier.

In some embodiments, the apparatus meets at least one of the following:
needing to send a message or response to the second terminal;
being a member terminal in a terminal group to which the second terminal belongs;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, where the target identifier is a terminal identifier, a terminal number, or a terminal index;
corresponding to a result of preset processing of the first identifier;
being a terminal that receives first indication information from a network-side device, where the first indication information is used to indicate any one of the following: activating the first information, deactivating the first information, using the first information, not using the first information, and stopping using the first information; and
being a terminal that receives fourth indication information from the network-side device, where the fourth indication information is used to indicate that the terminal can monitor or needs to monitor the second resource object.

In some embodiments, the apparatus 700 for processing sidelink transmission in an unlicensed band further includes:
a first execution module, configured to perform a third behavior in a case that a second preset condition is met, where
the third behavior includes at least one of the following: determining that a third terminal can monitor or needs to monitor a second resource object, where the second resource object at least partially overlaps the first resource object; and being allowed to or needing to use the second resource object;
the second preset condition includes at least one of the following: the apparatus finds that the first resource object is idle or available; the apparatus successfully obtains the first resource object; and the apparatus uses the first resource object; and
the third terminal is at least part of terminals corresponding to a same fourth identifier as the apparatus, where the fourth identifier is a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier.

In some embodiments, after the apparatus determines that the third terminal can monitor or needs to monitor the second resource object in the case that the second preset condition is met, the apparatus further performs the following:
the apparatus sends fifth indication information to the third terminal, where the fifth indication information is used to indicate at least one of the following: the third terminal can monitor the second resource object; the third terminal needs to monitor the second resource object; the third terminal uses the second resource object; the second resource object or a monitoring mode of the third terminal.

In some embodiments, the third terminal meets at least one of the following:
needing to send a message or response to the apparatus;
being a member terminal in a terminal group to which the apparatus belongs;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, where the target identifier is a terminal identifier, a terminal number, or a terminal index;
corresponding to a result of preset processing of the first identifier;
being a terminal that receives first indication information from a network-side device, where the first indication information is used to indicate any one of the following: activating the first information, deactivating the first information, using the first information, not using the first information, and stopping using the first information; and
being a terminal that receives sixth indication information from the network-side device, where the sixth indication information is used to indicate that the third terminal can monitor or needs to monitor the second resource object.

In some embodiments, the apparatus 700 for processing sidelink transmission in an unlicensed band further includes:
a first sending module, configured to send third information to a network-side device, where the third information includes at least one of the following:
an available channel occupancy time obtained by the apparatus;
fourth indication information about whether the first resource object is successfully obtained or used;
a monitoring mode for monitoring the first resource object;
terminal information of the apparatus;
hybrid automatic repeat request acknowledgement HARQ-ACK information corresponding to SL transmission of the apparatus; and
hybrid automatic repeat request acknowledgement HARQ-ACK information corresponding to an SL transmission failure of the apparatus.

In some embodiments, the monitoring information includes at least one of the following:
the number of monitoring or access attempts, or the maximum number of monitoring or access attempts;
the number of monitoring or access failures, or the maximum number of monitoring or access failures; and
a monitoring or access success interval, a maximum monitoring or access success interval, or a minimum monitoring or access success interval.

In some embodiments, the preset resource includes at least one of the following:
a time period;
a time resource corresponding to a timer;
the number of monitoring or access attempts, or a resource corresponding to the maximum number of monitoring or access attempts;
the number of monitoring or access failures, or a resource corresponding to the maximum number of monitoring or access failures; and
a monitoring or access success interval, or a resource corresponding to a maximum monitoring or access success interval.

In some embodiments, the information of the preset resource includes at least one of the following:
duration information;
time point information;
offset information; and
reference time point information.

In some embodiments, the monitoring a first resource object according to the first information includes:
monitoring whether the preset resource is idle or busy; and
monitoring whether the first resource object is idle or busy within a range of the preset resource.

In some embodiments, the preset resource includes at least two resource subsets, each resource subset is associated with at least one terminal, terminal group, terminal pair, or sixth identifier, and the first determining module 702 is configured to determine whether to perform the first behavior in a resource subset associated with the apparatus or whether the first behavior needs to be performed in a resource subset associated with the apparatus.

Referring to FIG. 8, an embodiment of this application provides an apparatus for processing sidelink transmission in an unlicensed band. As shown in FIG. 8, the apparatus 800 for processing sidelink transmission in an unlicensed band includes:
a second execution module 801, configured to perform a fourth behavior in a case that the apparatus knows target information, where
the target information includes at least one of the following: a second terminal determines that a first resource object is idle or available; the second terminal successfully accesses or obtains the first resource object; and the second terminal uses the first resource object;
the fourth behavior includes at least one of the following: determining that the first resource object is occupied by the second terminal; determining that the first resource object is occupied by a sidelink system; determining that the first resource object is occupied by at least part of terminals corresponding to a fifth identifier, where the at least part of the terminals corresponding to the fifth identifier include the second terminal; and determining second information in a case that the apparatus belongs to the at least part of the terminals corresponding to the fifth identifier; and
the second information includes at least one of the following: a second resource object, where the second resource object at least partially overlaps the first resource object; a requirement for monitoring the second resource object; a need to monitor the second resource object; and use of the second resource object.

In some embodiments, the determining second information in a case that the apparatus belongs to the at least part of the terminals corresponding to the fifth identifier includes:
determining the second information in a case that the apparatus belongs to the at least part of the terminals corresponding to the fifth identifier and receives seventh indication information sent by the second terminal, where
the seventh indication information is used to indicate at least one of the following: the second resource object; the apparatus can monitor the second resource object; the apparatus needs to monitor the second resource object; the apparatus uses the second resource object; the second resource object or a monitoring mode of the apparatus.

In some embodiments, the fourth behavior meets either of the following:
a monitoring mode of the second resource object is a second monitoring mode; and
the monitoring mode of the second resource object is determined based on an indication from a network-side device and/or based on a fourth identifier corresponding to the apparatus, where
the fourth identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of first preset information, an index of the first preset information, and a radio network temporary identifier.

In some embodiments, the apparatus meets at least one of the following:
needing to send a message or response to the second terminal;
being a member terminal in a terminal group to which the second terminal belongs;
corresponding to a preset third identifier;
corresponding to a first identifier associated with first preset information;
not corresponding to a second identifier associated with second preset information;
being a terminal whose target identifier is largest, whose target identifier is smallest, or whose target identifier is a first preset value among terminals corresponding to the first identifier, where the target identifier is a terminal identifier, a terminal number, or a terminal index;
corresponding to a result of preset processing of the first identifier; and
being a terminal that receives eighth indication information from a network-side device, where the eighth indication information is used to indicate that the terminal can monitor or needs to monitor the second resource object, where
the first preset information and/or the second preset information includes at least one of monitoring information and information of a preset resource.

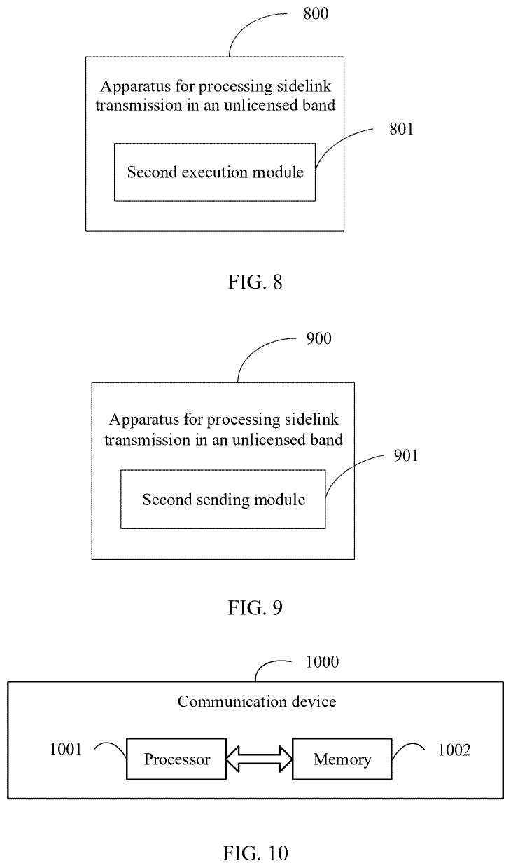

Referring to FIG. 9, an embodiment of this application provides an apparatus for processing sidelink transmission in an unlicensed band. As shown in FIG. 9, the apparatus 900 for processing sidelink transmission in an unlicensed band includes:
a second sending module 901, configured to send first information to a first terminal, where the first information includes at least one of first preset information and second preset information, and the first preset information and/or the second preset information includes at least one of monitoring information and information of a preset resource.

In some embodiments, the first preset information is associated with at least one first identifier, the second preset information is associated with at least one second identifier, and the apparatus 900 for processing sidelink transmission in an unlicensed band further includes a second determining module, where the second determining module is configured to perform at least one of the following:
when the first terminal meets a first correspondence, determining, by the first terminal, that the first terminal does not meet a first preset condition; and
when the first terminal meets a second correspondence, determining, by the first terminal, that the first terminal meets the first preset condition, where
the first correspondence includes at least one of the following:
the first terminal does not correspond to any one of the at least one first identifier;
the first terminal does not correspond to a preset first identifier of the at least one first identifier; and
the first terminal corresponds to the second identifier; and
the second correspondence includes at least one of the following:
the first terminal does not correspond to any one of the at least one second identifier;
the first terminal does not correspond to a preset second identifier of the at least one second identifier; and
the first terminal corresponds to the first identifier.

In some embodiments, the first identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, and a radio network temporary identifier; and/or
the second identifier includes at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the second preset information, an index of the second preset information, and a radio network temporary identifier.

In some embodiments, the first preset information meets at least one of the following:
indicating that M terminals are to monitor a first resource object in a first monitoring mode, where the M terminals include at least part of terminals associated with the first preset information, and M is a positive integer;
indicating that the M terminals are to use the first resource object;
indicating that the M terminals are to monitor the first resource object;
the first preset information includes terminal identifiers corresponding to the M terminals; and
the first preset information is associated with at least one first identifier, and the M terminals are at least part of terminals corresponding to the first identifier.

In some embodiments, the second preset information meets any one of the following:
indicating that N terminals are not to monitor a first resource object in a first monitoring mode, where the N terminals include at least part of terminals associated with the second preset information, and N is a positive integer;
indicating that the first resource object is not to be used;
indicating that the N terminals are not to monitor the first resource object;
the second preset information includes terminal identifiers corresponding to the N terminals; and
the second preset information is associated with at least one second identifier, and the N terminals are at least part of terminals corresponding to the second identifier.

In some embodiments, the second sending module 901 is further configured to send first indication information, where the first indication information is used to indicate any one of the following: activating the first information, deactivating the first information, using the first information, and stopping using the first information.

In some embodiments, the apparatus 900 for processing sidelink transmission in an unlicensed band further includes:
a second receiving module, configured to receive third information from the first terminal, where the third information includes at least one of the following:
an available channel occupancy time obtained by the first terminal;
fourth indication information about whether a first resource object is successfully obtained or used;
a monitoring mode for monitoring the first resource object;
terminal information of the first terminal;
hybrid automatic repeat request acknowledgement HARQ-ACK information corresponding to SL transmission of the first terminal; and
hybrid automatic repeat request acknowledgement HARQ-ACK information corresponding to an SL transmission failure of the first terminal.

In some embodiments, the monitoring information includes at least one of the following:
the number of monitoring or access attempts, or the maximum number of monitoring or access attempts;
the number of monitoring or access failures, or the maximum number of monitoring or access failures; and
a monitoring or access success interval, a maximum monitoring or access success interval, or a minimum monitoring or access success interval.

In some embodiments, the preset resource includes at least one of the following:
a time period;
a time resource corresponding to a timer;
the number of monitoring or access attempts, or a resource corresponding to the maximum number of monitoring or access attempts;
the number of monitoring or access failures, or a resource corresponding to the maximum number of monitoring or access failures; and
a monitoring or access success interval, or a resource corresponding to a maximum monitoring or access success interval.

In some embodiments, the information of the preset resource includes at least one of the following:
duration information;
time point information;
offset information; and
reference time point information.

The apparatus for processing sidelink transmission in an unlicensed band in this embodiment of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a network attached storage (NAS), and the like. This is not specifically limited in this embodiment of this application.

The apparatus for processing sidelink transmission in an unlicensed band according to this embodiment of this application can implement each process implemented in the method embodiments in FIG. 2 to FIG. 6, with the same technical effect achieved. To avoid repetition, details are not described herein again.

In some embodiments, as shown in FIG. 10, an embodiment of this application further provides a communication device 1000, including a processor 1001 and a memory 1002. The memory 1002 stores a program or instructions capable of running on the processor 1001. When the program or instructions are executed by the processor 1001, the steps of the foregoing embodiment of the apparatus for processing sidelink transmission in an unlicensed band are implemented, with the same technical effect achieved. To avoid repetition, details are not described herein again.

An embodiment of this application further provides a terminal, including a processor and a communication interface. When the terminal is a first terminal, the communication interface is configured to obtain first information, where the first information includes at least one of first preset information and second preset information, and the first preset information and/or the second preset information includes at least one of monitoring information and information of a preset resource; and the processor is configured to determine whether to perform a first behavior or whether a first behavior needs to be performed, where the first behavior includes at least one of: monitoring a first resource object according to the first information and using the first resource object according to the first information, where
in a case that a first preset condition is met, the first terminal determines to perform the first behavior or that the first behavior needs to be performed, and the first preset condition includes at least one of the following: the first terminal belongs to M terminals that include at least part of terminals associated with the first preset information, and the first terminal does not belong to N terminals that include at least part of terminals associated with the second preset information, where both M and N are positive integers.

In some embodiments, when the terminal is a fourth terminal, the processor is configured to perform a fourth behavior in a case that the fourth terminal knows target information, where
the target information includes at least one of the following: a second terminal determines that a first resource object is idle or available; the second terminal successfully accesses or obtains the first resource object; and the second terminal uses the first resource object;
the fourth behavior includes at least one of the following: determining that the first resource object is occupied by the second terminal; determining that the first resource object is occupied by a sidelink system; determining that the first resource object is occupied by at least part of terminals corresponding to a fifth identifier, where the at least part of the terminals corresponding to the fifth identifier include the second terminal; and determining second information in a case that the fourth terminal belongs to the at least part of the terminals corresponding to the fifth identifier; and
the second information includes at least one of the following: a second resource object, where the second resource object at least partially overlaps the first resource object; a requirement for monitoring the second resource object; a need to monitor the second resource object; and use of the second resource object.

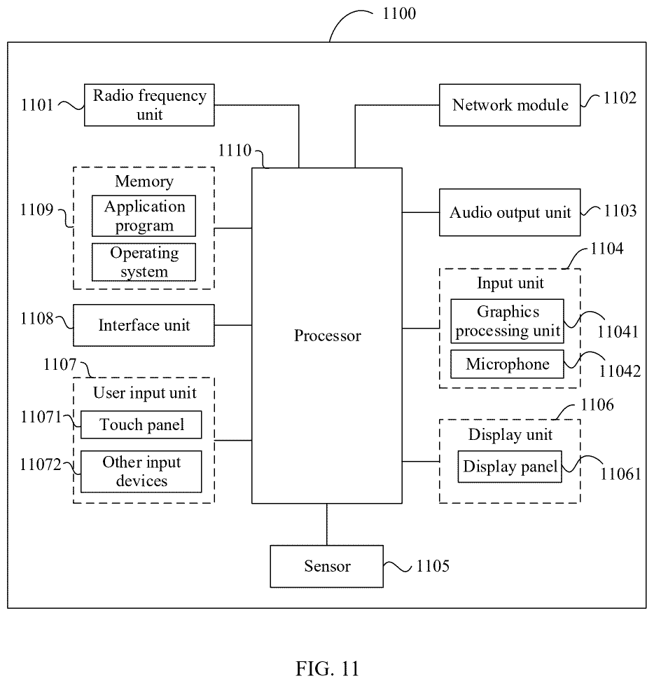

The terminal embodiment corresponds to the foregoing terminal-side method embodiment, and each implementation process and implementation of the foregoing method embodiment can be applied to the terminal embodiment, with the same technical effect achieved. In some embodiments, FIG. 11 is a schematic diagram of a hardware structure of a terminal for implementing an embodiment of this application.

The terminal 1100 includes but is not limited to at least some components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art may understand that the terminal 1100 may further include a power supply (for example, a battery) supplying power to all components. The power supply may be logically connected to the processor 1110 through a power management system. In this way, functions such as charge management, discharge management, and power consumption management are implemented by using the power management system. The terminal structure shown in FIG. 11 does not constitute a limitation on the terminal. The terminal may include more or fewer components than those shown in the figure, or some components are combined, or component arrangements are different. Details are not described herein again.

It should be understood that, in this embodiment of this application, the input unit 1104 may include a graphics processing unit (GPU) 11041 and a microphone 11042. The graphics processing unit 11041 processes image data of a still picture or video obtained by an image capture apparatus (such as a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and other input devices 11072. The touch panel 11071 is also referred to as a touchscreen. The touch panel 11071 may include two parts: a touch detection apparatus and a touch controller. The other input devices 11072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 1101 may transmit the downlink data to the processor 1110 for processing. In addition, the radio frequency unit 1101 may send uplink data to the network-side device. Usually, the radio frequency unit 1101 includes but is not limited to an antenna, an amplifier, a transceiver, a coupler, a low noise amplifier, a duplexer, and the like.

The memory 1109 may be configured to store software programs or instructions and various data. The memory 1109 may primarily include a first storage area for storing programs or instructions and a second storage area for storing data. The first storage area may store an operating system, an application program or instructions required by at least one function (such as an audio play function and an image play function), and the like. In addition, the memory 1109 may include a volatile memory or a non-volatile memory, or the memory 1109 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), and a Direct Rambus RAM (DRRAM). The memory 1109 in this embodiment of this application includes but is not limited to these and any other suitable types of memories.

The processor 1110 may include one or more processing units. In some embodiments, the processor 1110 integrates an application processor and a modem processor. The application processor mainly processes operations related to the operating system, a user interface, an application program, and the like. The modem processor mainly processes a wireless communication signal. For example, the modem processor is a baseband processor. In some embodiments, it may be understood that the modem processor may be not integrated in the processor 1110.

When the terminal is a first terminal, the radio frequency unit 1101 is configured to obtain first information, where the first information includes at least one of first preset information and second preset information, and the first preset information and/or the second preset information includes at least one of monitoring information and information of a preset resource; and the processor 1110 is configured to determine whether to perform a first behavior or whether a first behavior needs to be performed, where the first behavior includes at least one of: monitoring a first resource object according to the first information and using the first resource object according to the first information, where
in a case that a first preset condition is met, the first terminal determines to perform the first behavior or that the first behavior needs to be performed, and the first preset condition includes at least one of the following: the first terminal belongs to M terminals that include at least part of terminals associated with the first preset information, and the first terminal does not belong to N terminals that include at least part of terminals associated with the second preset information, where both M and N are positive integers.

In some embodiments, when the terminal is a fourth terminal, the processor 1110 is configured to perform a fourth behavior in a case that the fourth terminal knows target information, where
the target information includes at least one of the following: a second terminal determines that a first resource object is idle or available; the second terminal successfully accesses or obtains the first resource object; and the second terminal uses the first resource object;
the fourth behavior includes at least one of the following: determining that the first resource object is occupied by the second terminal; determining that the first resource object is occupied by a sidelink system; determining that the first resource object is occupied by at least part of terminals corresponding to a fifth identifier, where the at least part of the terminals corresponding to the fifth identifier include the second terminal; and determining second information in a case that the fourth terminal belongs to the at least part of the terminals corresponding to the fifth identifier; and
the second information includes at least one of the following: a second resource object, where the second resource object at least partially overlaps the first resource object; a requirement for monitoring the second resource object; a need to monitor the second resource object; and use of the second resource object.

An embodiment of this application further provides a network-side device, including a processor and a communication interface. The communication interface is configured to send first information to a first terminal, where the first information includes at least one of first preset information and second preset information, and the first preset information and/or the second preset information includes at least one of monitoring information and information of a preset resource. The network-side device embodiment corresponds to the foregoing method embodiment of the network-side device, and each implementation process and implementation of the foregoing method embodiment can be applied to the network-side device embodiment, with the same technical effect achieved.

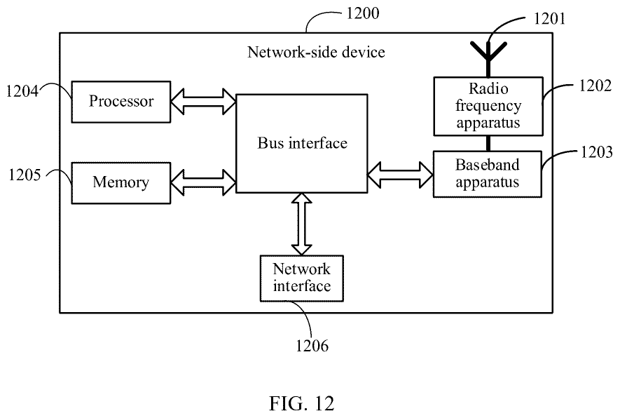

In some embodiments, an embodiment of this application further provides a network-side device. As shown in FIG. 12, the network-side device 1200 includes an antenna 1201, a radio frequency apparatus 1202, a baseband apparatus 1203, a processor 1204, and a memory 1205. The antenna 1201 is connected to the radio frequency apparatus 1202. In an uplink direction, the radio frequency apparatus 1202 receives information by using the antenna 1201, and sends the received information to the baseband apparatus 1203 for processing. In a downlink direction, the baseband apparatus 1203 processes to-be-sent information, and sends the information to the radio frequency apparatus 1202; and the radio frequency apparatus 1202 processes the received information and then sends the information out by using the antenna 1201.

The method performed by the network-side device in the foregoing embodiment may be implemented in the baseband apparatus 1203. The baseband apparatus 1203 includes a baseband processor.

The baseband apparatus 1203 may include, for example, at least one baseband unit, where a plurality of chips are disposed on the baseband unit. As shown in FIG. 12, one of the chips is, for example, the baseband processor, connected to the memory 1205 by using a bus interface, to invoke a program in the memory 1205 to perform the operation of the network-side device shown in the foregoing method embodiment.

The network-side device may further include a network interface 1206, where the interface is, for example, a common public radio interface (CPRI).

For example, the network-side device 1200 in this embodiment of this application further includes a program or instructions stored in the memory 1205 and capable of running on the processor 1204. When the processor 1204 invokes the program or instructions in the memory 1205, the method performed by each module shown in FIG. 9 is performed, with the same technical effect achieved. To avoid repetition, details are not described herein again.

An embodiment of this application further provides a readable storage medium. The readable storage medium stores a program or instructions. When the program or instructions are executed by a processor, each process of the foregoing method embodiment of the method for processing sidelink transmission in an unlicensed band is implemented, with the same technical effect achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the method for processing sidelink transmission in an unlicensed band, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing embodiment of the method for processing sidelink transmission in an unlicensed band, with the same technical effect achieved. To avoid repetition, details are not described herein again.

An embodiment of this application further provides a communication system, including a terminal and a network-side device. The terminal is configured to perform each process shown in FIG. 2 to FIG. 5 and the foregoing method embodiments corresponding to the terminals. The network-side device is configured to perform each process in FIG. 6 and the foregoing method embodiments corresponding to the network-side devices, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and may be implemented by using hardware. However, in most cases, the former is a preferred implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A method for processing sidelink transmission in an unlicensed band, comprising:
obtaining, by a first terminal, first information, wherein the first information comprises first preset information, and the first preset information comprises information of a preset resource, the preset resource comprises a resource corresponding to the maximum number of monitoring failures or access failures; and
determining, by the first terminal, to perform a first behavior or a first behavior needs to be performed, when a first preset condition is met, wherein
the first behavior comprises using the first resource object according to the first information, and the first preset condition comprises: the first terminal belongs to M terminals that comprise at least part of terminals associated with the first preset information, wherein M is positive integer.

2. The method according to claim 1, wherein the first preset information is associated with at least one first identifier, and the method further comprises:
when the first terminal meets a first correspondence, determining, by the first terminal, that the first terminal does not meet the first preset condition, wherein
the first correspondence comprises at least one of the following:
the first terminal does not correspond to any one of the at least one first identifier;
the first terminal does not correspond to a preset first identifier of the at least one first identifier; or
the first terminal corresponds to the second identifier.

3. The method according to claim 2, wherein the first identifier comprises at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, or a radio network temporary identifier.

4. The method according to claim 1, wherein the first preset information meets at least one of the following:
indicating that the M terminals are to monitor the first resource object;
indicating that the M terminals are to monitor the first resource object in a first monitoring mode;
indicating that the M terminals are to use the first resource object;
the first preset information comprises terminal identifiers corresponding to the M terminals; or
the first preset information is associated with at least one first identifier, and the M terminals are at least part of terminals corresponding to the first identifier.

5. The method according to claim 1, wherein the obtaining, by the first terminal, the first information comprises:
receiving, by the first terminal, the first information from a network-side device, wherein
the first information is carried by at least one of the following: downlink control information (DCI), radio resource control (RRC) signaling, or media access control (MAC) signaling.

6. The method according to claim 1, further comprising:
receiving, by the first terminal, first indication information from a network-side device, wherein the first indication information is used to indicate any one of the following: activating the first information, deactivating the first information, using the first information, not using the first information, or stopping using the first information.

7. The method according to claim 1, wherein the M terminals meet at least one of the following:
being a header terminal in a group;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, wherein the target identifier is a terminal identifier, a terminal number, or a terminal index;
corresponding to a result of preset processing of the first identifier; or
being a terminal that receives second indication information from a network-side device, wherein the second indication information is used to indicate that the terminal can monitor or needs to monitor the first resource object, wherein
the third identifier comprises at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, or a radio network temporary identifier.

8. The method according to claim 1, wherein the first behavior meets either of the following:
a monitoring mode of the first resource object is a first monitoring mode; or
the monitoring mode of the first resource object is determined based on an indication from a network-side device or based on a fourth identifier corresponding to the first terminal, wherein
the fourth identifier comprises at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, or a radio network temporary identifier.

9. The method according to claim 1, wherein after the determining, by the first terminal, to perform the first behavior or the first behavior needs to be performed, the method further comprises:
when the first terminal knows target information, performing, by the first terminal, a second behavior, wherein
the target information comprises at least one of the following: a second terminal determines that the first resource object is idle or available; the second terminal successfully accesses or obtains the first resource object; or the second terminal uses the first resource object,
the second behavior comprises at least one of the following: determining that the first resource object is occupied by the second terminal; determining that the first resource object is occupied by a sidelink system; determining that the first resource object is occupied by at least part of terminals corresponding to a fifth identifier, wherein the at least part of the terminals corresponding to the fifth identifier comprise the second terminal; or determining second information when the first terminal belongs to the at least part of the terminals corresponding to the fifth identifier, and
the second information comprises at least one of the following: a second resource object, wherein the second resource object at least partially overlaps the first resource object; a requirement for monitoring the second resource object; a need to monitor the second resource object; or use of the second resource object, wherein
the determining second information when the first terminal belongs to the at least part of the terminals corresponding to the fifth identifier comprises:
determining the second information when the first terminal belongs to the at least part of the terminals corresponding to the fifth identifier and receives third indication information sent by the second terminal, wherein the third indication information is used to indicate at least one of the following: the second resource object; the first terminal can monitor the second resource object; the first terminal needs to monitor the second resource object; the first terminal uses the second resource object; the second resource object; or a monitoring mode of the first terminal,
the second behavior meets either of the following:
a monitoring mode of the second resource object is a second monitoring mode; or
the monitoring mode of the second resource object is determined based on an indication from a network-side device or based on a fourth identifier corresponding to the first terminal, wherein the fourth identifier comprises at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, or a radio network temporary identifier, or the first terminal meets at least one of the following:
needing to send a message or response to the second terminal;
being a member terminal in a terminal group to which the second terminal belongs;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, wherein the target identifier is a terminal identifier, a terminal number, or a terminal index;
corresponding to a result of preset processing of the first identifier;
being a terminal that receives first indication information from a network-side device, wherein the first indication information is used to indicate any one of the following: activating the first information, deactivating the first information, using the first information, not using the first information, or stopping using the first information; or
being a terminal that receives fourth indication information from the network-side device, wherein the fourth indication information is used to indicate that the terminal can monitor or needs to monitor the second resource object.

10. The method according to claim 1, wherein after the determining, by the first terminal, to perform the first behavior or the first behavior needs to be performed, when a first preset condition is met, the method further comprises:
when a second preset condition is met, performing, by the first terminal, a third behavior, wherein
the third behavior comprises at least one of the following: determining that a third terminal can monitor or needs to monitor a second resource object, wherein the second resource object at least partially overlaps the first resource object; or being allowed to or needing to use the second resource object,
the second preset condition comprises at least one of the following: the first terminal finds that the first resource object is idle or available; the first terminal successfully obtains the first resource object; or the first terminal uses the first resource object, and
the third terminal is at least part of terminals corresponding to a same fourth identifier as the first terminal, wherein the fourth identifier is a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, or a radio network temporary identifier.

11. The method according to claim 10, wherein after the first terminal determines that the third terminal can monitor or needs to monitor the second resource object when the second preset condition is met, the method further comprises:
sending, by the first terminal, fifth indication information to the third terminal, wherein the fifth indication information is used to indicate at least one of the following: the third terminal can monitor the second resource object; the third terminal needs to monitor the second resource object; the third terminal uses the second resource object; the second resource object; or a monitoring mode of the third terminal, and
wherein the third terminal meets at least one of the following:
needing to send a message or response to the first terminal;
being a member terminal in a terminal group to which the first terminal belongs;
corresponding to a preset third identifier;
corresponding to a first identifier associated with the first preset information;
not corresponding to a second identifier associated with the second preset information;
being a terminal whose target identifier is largest, whose target identifier is smallest, or whose target identifier is a first preset value among terminals corresponding to the first identifier, wherein the target identifier is a terminal identifier, a terminal number, or a terminal index;
corresponding to a result of preset processing of the first identifier;
being a terminal that receives first indication information from a network-side device, wherein the first indication information is used to indicate any one of the following: activating the first information, deactivating the first information, using the first information, not using the first information, or stopping using the first information; or
being a terminal that receives sixth indication information from the network-side device, wherein the sixth indication information is used to indicate that the third terminal can monitor or needs to monitor the second resource object.

12. The method according to claim 1, further comprising:
sending, by the first terminal, third information to a network-side device, wherein the third information comprises at least one of the following:
an available channel occupancy time obtained by the first terminal;
fourth indication information about whether the first resource object is successfully obtained or used;
a monitoring mode for monitoring the first resource object;
terminal information of the first terminal;
hybrid automatic repeat request acknowledgement (HARQ-ACK) information corresponding to sidelink transmission of the first terminal; or
HARQ-ACK information corresponding to a sidelink transmission failure of the first terminal, or
wherein the preset resource comprises at least two resource subsets, each resource subset is associated with at least one terminal, terminal group, terminal pair, or sixth identifier, and the determining, by the first terminal, whether to perform the first behavior or whether the first behavior needs to be performed comprises:
determining, by the first terminal, whether to perform the first behavior in a resource subset associated with the first terminal or whether the first behavior needs to be performed in a resource subset associated with the first terminal.

13. A method for processing sidelink transmission in an unlicensed band, comprising:
sending, by a network-side device, first information to a first terminal, wherein the first information comprises first preset information, and the first preset information comprises information of a preset resource, the preset resource comprises a resource corresponding to the maximum number of monitoring failures or access failures.

14. The method according to claim 13, wherein the first preset information is associated with at least one first identifier, and the method further comprises:
when the first terminal meets a first correspondence, determining, by the network-side device, that the first terminal does not meet a first preset condition, wherein
the first correspondence comprises at least one of the following:
the first terminal does not correspond to any one of the at least one first identifier;
the first terminal does not correspond to a preset first identifier of the at least one first identifier; or
the first terminal corresponds to the second identifier.

15. The method according to claim 14, wherein the first identifier comprises at least one of the following: a source identifier, a destination identifier, an identifier corresponding to a terminal group, an identifier of a member in a group, an identifier corresponding to a terminal pair, an identifier corresponding to a service, an identifier corresponding to a profile, an identifier of a quality of service flow, an identifier of a resource pool, a carrier identifier, an identifier of a bandwidth part, an identifier of a subgroup to which a terminal belongs, an identifier of a resource block set, an identifier of a channel, an identifier of a subchannel, an index of the first preset information, an index of the first preset information, or a radio network temporary identifier.

16. The method according to claim 13, wherein the first preset information meets at least one of the following:
indicating that the M terminals are to monitor the first resource object;
indicating that M terminals are to monitor a first resource object in a first monitoring mode, wherein the M terminals comprise at least part of terminals associated with the first preset information, and M is a positive integer;
indicating that the M terminals are to use the first resource object;
the first preset information comprises terminal identifiers corresponding to the M terminals; or
the first preset information is associated with at least one first identifier, and the M terminals are at least part of terminals corresponding to the first identifier.

17. The method according to claim 13, further comprising:
sending, by the network-side device, first indication information, wherein the first indication information is used to indicate any one of the following: activating the first information, deactivating the first information, using the first information, or stopping using the first information.

18. The method according to claim 13, further comprising:
receiving, by the network-side device, third information from the first terminal, wherein the third information comprises at least one of the following:
an available channel occupancy time obtained by the first terminal;
fourth indication information about whether a first resource object is successfully obtained or used;
a monitoring mode for monitoring the first resource object;
terminal information of the first terminal;
hybrid automatic repeat request acknowledgement (HARQ-ACK) information corresponding to sidelink transmission of the first terminal; or
HARQ-ACK information corresponding to a sidelink transmission failure of the first terminal.

19. The method according to claim 13, wherein the monitoring information comprises at least one of the following:
the number of monitoring or access attempts, or the maximum number of monitoring or access attempts;
the number of monitoring or access failures, or the maximum number of monitoring or access failures; or
a monitoring or access success interval, a maximum monitoring or access success interval, or a minimum monitoring or access success interval, or
the preset resource comprises at least one of the following:
a time period;
a time resource corresponding to a timer;
the number of monitoring or access attempts, or a resource corresponding to the maximum number of monitoring or access attempts;
the number of monitoring or access failures, or a resource corresponding to the maximum number of monitoring or access failures; or
a monitoring or access success interval, or a resource corresponding to a maximum monitoring or access success interval.

20. A terminal, comprising a processor and a memory storing instructions, wherein the instructions, when executed by the processor, cause the processor to perform operations comprising:
obtaining first information, wherein the first information comprises first preset information, and the first preset information comprises information of a preset resource, the preset resource comprises a resource corresponding to the maximum number of monitoring failures or access failures; and
determining to perform a first behavior or a first behavior needs to be performed, when a first preset condition is met, wherein
the first behavior comprises using the first resource object according to the first information, and the first preset condition comprises: the first terminal belongs to M terminals that comprise at least part of terminals associated with the first preset information, wherein M is positive integers.
